(19) United States
(12) Patent Application Publication
(10) Pub. No.: US 2016/0352790 A1
(43) Pub. Date: Dec. 1, 2016

(54) COLLABORATIVE BUSINESS COMMUNICATION INFORMATION SYSTEM

(71) Applicant: GREY RIVER GROUP, LLC, Morrisville, NC (US)

(72) Inventors: Michael J. Hollingsworth, Chapel Hill, NC (US); Michael W. Ippolito, Cary, NC (US); Matthew P. McHugh, Garner, NC (US)

(21) Appl. No.: 15/117,953

(22) PCT Filed: Feb. 11, 2014
(86) PCT No.: PCT/US14/15730

§ 371 Date: Aug. 10, 2016

(51) Int. Cl. H04L 29/06; H04L 12/66; H04M 3/56; H04L 29/12; H04L 12/46; H04L 29/08

(52) U.S. Cl. CPC H04L 65/403; H04L 12/4641; H04L 67/26; H04M 3/56; H04L 61/2007; H04L 12/66; H04L 67/1038; H04L 67/18; H04L 67/303; H04L 63/0428; H04L 63/10; H04L 63/0272; H04L 63/1416; H04L 63/1441; H04L 63/0861; H04L 63/107

(57) ABSTRACT

A collaborative business communication information system that includes one or more communication devices communicatively coupled to one or more networks, and a virtual private network (VPN) accessible by the one or more communication devices via a communication access network. The VPN is configured to provision the one or more communication devices to communicate within the VPN, monitor communication data between the one or more communication devices, encrypt the communication data during transmission and when stored within the VPN, detect and block intrusive activity of the communication data in real-time, and perform a switching operation between the one or more networks in real-time, to provide an uninterrupted communication path between the one or more communication devices in communication with each other.

### BACKGROUND OF THE INVENTION

1. Field of the Invention

The present invention relates to a collaborative business communication information system. More particularly, the present invention relates to a collaborative business communication information system and management and operation of communication devices within the system.

2. Description of the Related Art

A communication network system typically includes a plurality of communication devices which communicate with each other over a network, e.g., a wireless communication network, wireline or fixed communication network or the Internet. The network may be a public network, and therefore creates security concerns when privacy is desired. Therefore, a Virtual Private Network (VPN) may be implemented for establishing a private data communication network in a public network relying on a communications service provider such as a Network Service Provider (NSP). The VPN may be one of two types, a fixed VPN and a mobile VPN. The fixed VPN provides VPN access through a fixed communication network and the mobile VPN provides communication with VPN access through mobile communication networks. However, there are several problems associated with the current VPN technology including, for example, non-continuous communication service (e.g., dropped calls), mobile network operating system compatibility concerns, and network security issues.

### SUMMARY OF THE INVENTION

The present invention provides a collaborative business communication information system that supports one or more virtual private networks (VPNs) and is compatible with various network operating systems, whether mobile or fixed network operating systems, to obviate compatibility concerns.

According to one or more embodiments, the present invention provides a collaborative business communication information system, comprising one or more communication devices communicatively coupled to one or more networks, and a virtual private network (VPN) accessible by the one or more communication devices via a communication access network. The communication devices can, for example, be mobile communication devices such as smart phones, tablets and laptop computers, or fixed or stationary communication devices such as workstation computers, desktop phones including VoIP phones and servers. The VPN is configured to provision the one or more communication devices to communicate within the VPN, monitor communication data between the one or more communication devices, encrypt the communication data during transmission and when stored within the VPN LAN and VPN DMZ LAN, detect and block intrusive activity of the communication data in real-time, and perform a switching operation between the one or more networks in real-time, to provide an uninterrupted communication path between the one or more communication devices in communication with each other.

According to one or more embodiments, the present invention provides a collaborative business communication information system capable of provisioning one or more communication devices for communication with communication devices internal to and external of the system.

According to one or more embodiments, the present invention provides a collaborative business communication information system functioning as a hybrid private cloud network.

According to one or more embodiments, the present invention provides a collaborative business communication information system that includes a private topography whereby users communicate within a closed network based on geographical location and/or organization or company association.

According to one or more embodiments, the present invention provides a collaborative business communication information system that includes a semi-private topography whereby users within the system are able to communicate with users outside of the system.

According to one or more embodiments, the system of the present invention is a dual VPN system.

According to one or more embodiments, the present invention provides a data encryption method which encrypts data multiple times to provide increased security protection with the system.

According to one or more embodiments, the present invention provides designed-in security measures for the system such as biometric verification procedures and device and network diagnostics, to thereby give users a protected environment in which to communicate.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto, wherein in the following brief description of the drawings:

FIG. 1 is a block diagram of a collaborative business communication information system that can be implemented within one or more embodiments of the present invention.

FIG. 2 is a block diagram of a collaborative business communication information system that can be implemented within alternative embodiments of the present invention.

FIG. 3 is a flowchart illustrating a method provisioning a communication device for use within the collaborative business communication information system according to one or more embodiments of the present invention.

FIG. 4 is a computing system that can be implemented within one or more embodiments of the present invention.

FIG. 5 is a flowchart illustrating a method of performing an incoming call operation via a communication device within the collaborative business communication information system according to one or more embodiments of the present invention.

FIG. 6 is a flowchart illustrating a method of performing an outbound call operation via a communication device within the collaborative business communication information system according to one or more embodiments of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

Specific details are given in the following description to provide a thorough understanding of the embodiments. However, it will be understood by one of ordinary skill in the art that the embodiments may be practiced without these specific details. For example, systems, networks, processes, and other components may be shown as components in block diagram form in order not to obscure the embodiments in unnecessary detail. Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

The present invention as will be described in greater detail below provides a collaborative business communication information system that supports one or more virtual private networks (VPNs) and is compatible with various network operating systems, whether mobile or fixed network operating systems, to obviate compatibility concerns. The present invention provides various embodiments as described below. However it should be noted that the present invention is not limited to the embodiments described herein, but could extend to other embodiments as would be known or as would become known to those skilled in the art.

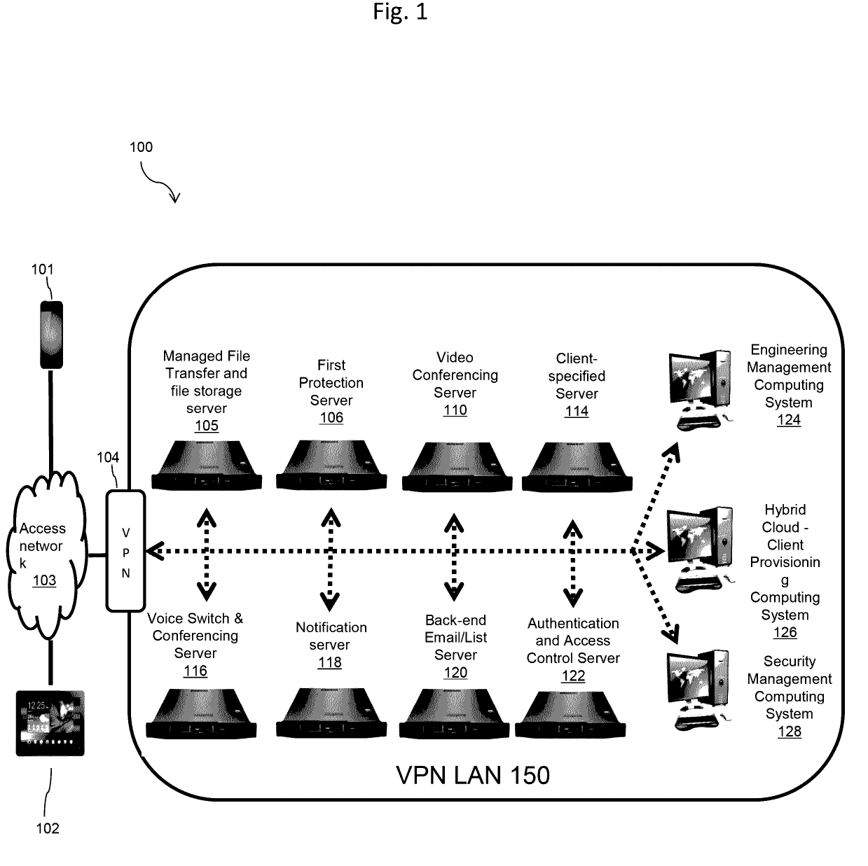

FIG. 1 is a block diagram of a collaborative business communication information system 100 implemented within one or more embodiments of the present invention. In FIG. 1, one or more users may access the system 100 using a communication device 101, 102 such as a mobile communication device (e.g., a smartphone) or fixed communication device (e.g., a desk phone, voice over internet protocol (VoIP phone) or personal computing system) which is configured to include computing capabilities and network (e.g., Internet) connectivity. The communication device 101 may be a smartphone that includes at least one or more sensors, cameras, a microphone, and a display device (e.g., touchscreen display) for manipulating the smartphone. The communication devices 101,102 may also be a portable computer (e.g., a tablet) that includes computing capabilities, and network connectivity. The communication devices 101, 102 may be used to access the system 100 through a communication access network 103 (e.g., Wi-Fi or Bluetooth technology). The communication access network 103 may be inclusive of one or more wired and/or wireless networks for providing access to the system 100 using both wired and wireless connections between communication devices 101, 102, and therefore may perform switching between the networks when necessary to maintain a communication path between multiple communication devices 101, 102. The access to the system 100 may be provided by mobile broadband built into an access device or access point feed from various communication access devices.

According to one or more embodiments, the user accesses a VPN gateway 104 within the system 100 using the communication access network 103. The VPN of the present invention may be a fixed VPN that provides users with VPN access through a fixed communication network using fixed communication devices 101, 102 such as a VoIP phones). The VPN may therefore be an Internet Protocol (IP) security based protocol suite for securing IP communications by authenticating and encrypting each IP packet of a communication session. The IP security based VPN provides connectivity between remote communication devices where only one communication device 101, 102 is installed with client side software or through the VPN gateway 104 directly.

Alternatively, according to one or more embodiments, the VPN may be a mobile VPN accessible using wireless networks. The mobile VPN allows the communication devices (e.g., mobile devices) 101, 102 to move through service provider network cells or roam through different networks when in close proximity. Therefore, the communication devices 101, 102 may switch through different networks such that the communication is persistent (i.e., uninterrupted) and the application sessions are maintained even when connectivity is temporarily lost or diminished.

According to one or more embodiments, when the VPN is a mobile VPN, the switching of networks is transparent to the user. The application interface remains the same and does not require modification of the application. Thus, the bandwidth optimization the mobile VPN reduces network bandwidth consumption and reduces network costs.

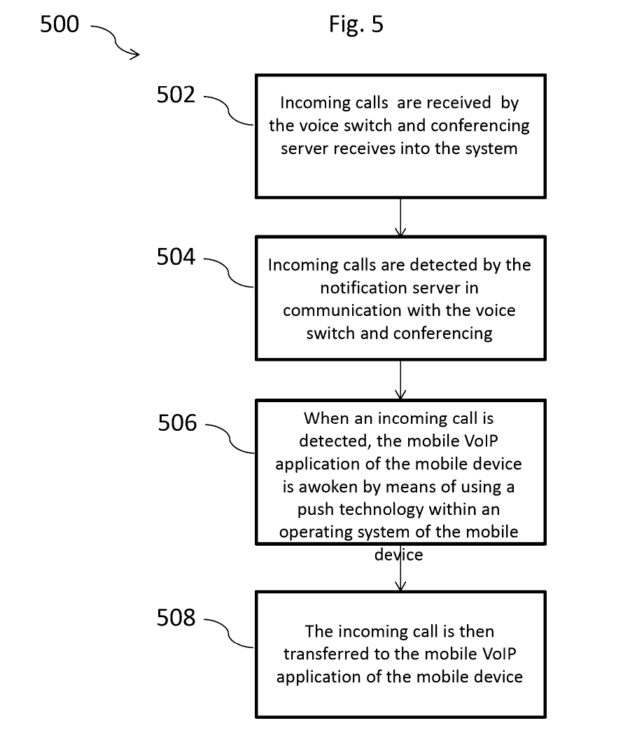

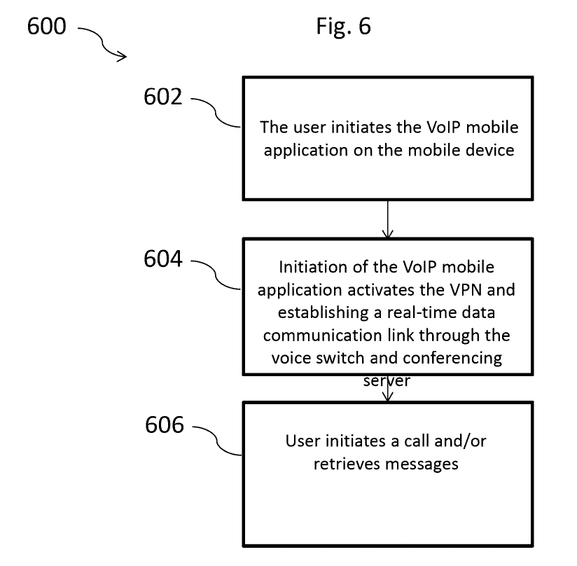

The methods for communicating between the communication devices 101, 102 will be discussed below with reference to the flow diagrams shown in FIGS. 5 and 6.

According to one or more embodiments, the system 100 provides added security measures by performing multiple encryption processes whereby data traffic external or via the communication devices 101, 102 is encrypted one or more times when being transmitted in the system 100. The encryption process may be performed at a transport layer level. A first encryption process is performed for data (voice, text or video) of the mobile device 101, 102 using a datagram transport layer security (DTLS), transport layer security (TLS) or secure real-time transport (SRTP). A second encryption process may be performed once the data is through the VPN tunnel using one of the above-mentioned security protocols. Therefore, the multiple encryption method performed protects the communication data. The present invention is not limited to performance of any particular number of encryption processes or manner in which the data is encrypted and therefore any suitable encryption process for the purposes set forth herein may be implemented.

According to one or more embodiments, the system 100 further comprises a VPN local area network (LAN) 150 connected with the VPN gateway 104. The VPN LAN 150 has several LAN segments (e.g., servers, computing systems, etc.) which are interconnected with each other. The VPN gateway 104 is in communication with all of the LAN segments within the VPN LAN 150 (as indicated by the dashed arrows shown in FIG. 1). The VPN LAN 150 is protected by the VPN gateway 104 (e.g., a fixed VPN and a mobile VPN) and all data traveling within the VPN LAN 150 is continuously monitored to detect any potential breach of the system 100.

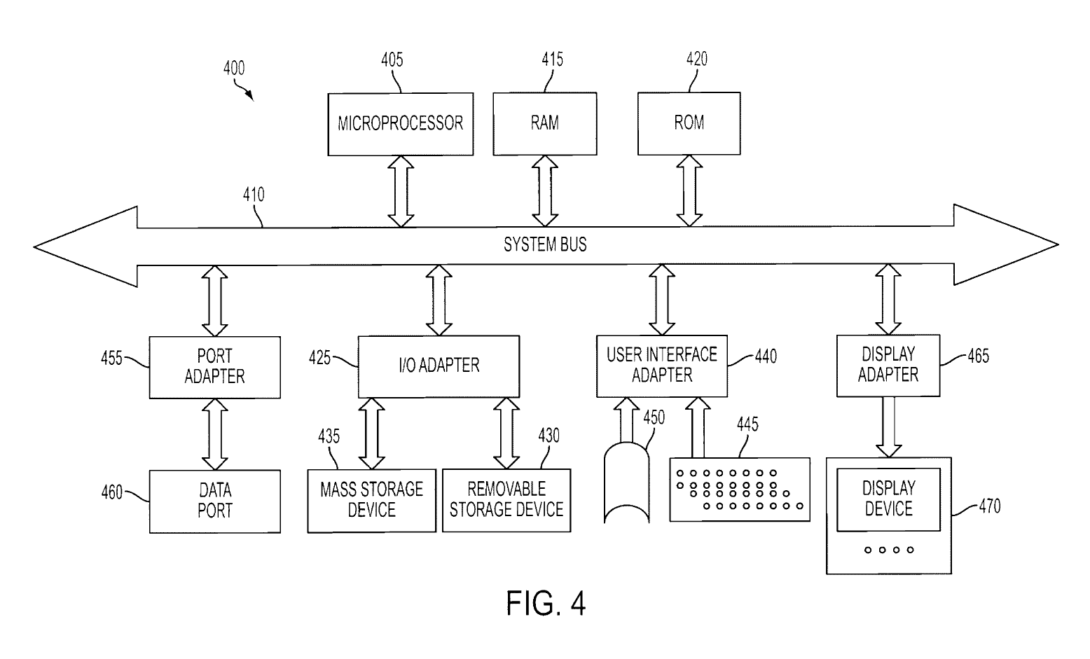

The LAN segments of the VPN LAN 150 comprise a managed file transfer and file storage server 105 (i.e., a file server), a first protection server 106, a video conferencing server 110, a client-specified server 114, a voice switch and conferencing server 116, a notification server 118, a backend email/list server, and an authentication and access control server 122. The LAN segments further comprises multiple computing systems including an engineering management computing system 124, a hybrid cloud—client provisioning computing system 126 and a security management computing system 128. Each server 105, 106, 110, 114, 116, 118 and 122 and computing systems 124, 126 and 128 can include a server component including a dedicated computing device having a hardware configuration as shown in FIG. 4, and one or more software applications to be implemented thereon, for making requests and responding to requests from each other, and from the communication devices 101, 102, within the VPN LAN 150.

Administrators of the system 100 may implement VPN policy changes and load or push the changes dynamically using the computing systems 124, 126 and 128 without interrupting communication sessions in progress. The VPN LAN 150 is not limited to any particular number of servers, computing systems and other components and may vary accordingly.

According to one or more embodiments, the file server 105 is configured to manage file transfer and storage thereof. The server 105 comprises a storage for storing data, and software applications associated therewith to facilitate secure transfer of data from one communication device 101, 102 to another communication device 101, 102 through the system 100. According to one or more embodiments, the file server 105 is also configured to gather data and analyze data using a processor of the server 105, and perform reporting such as statistical use reporting and audit reporting, notification responses related to file transfer processes and end-to-end security by means of secure socket layer (SSL) protocol, for example. Therefore, any data transiting and stored within the system 100 is protected. According to one or more embodiments, the file server 105 is capable of transferring and blocking file extensions along with performing malware scans of all uploaded files or documents, prior to performing the transfer. Therefore, data is protected at rest and during transmission. Further, the file server 105 is further configured to assist with the authentication users of the communication devices 101, 102 at the communication device 101, 102 when attempting to gain access to the VPN LAN 150 using an active directory of authorized users stored therein.

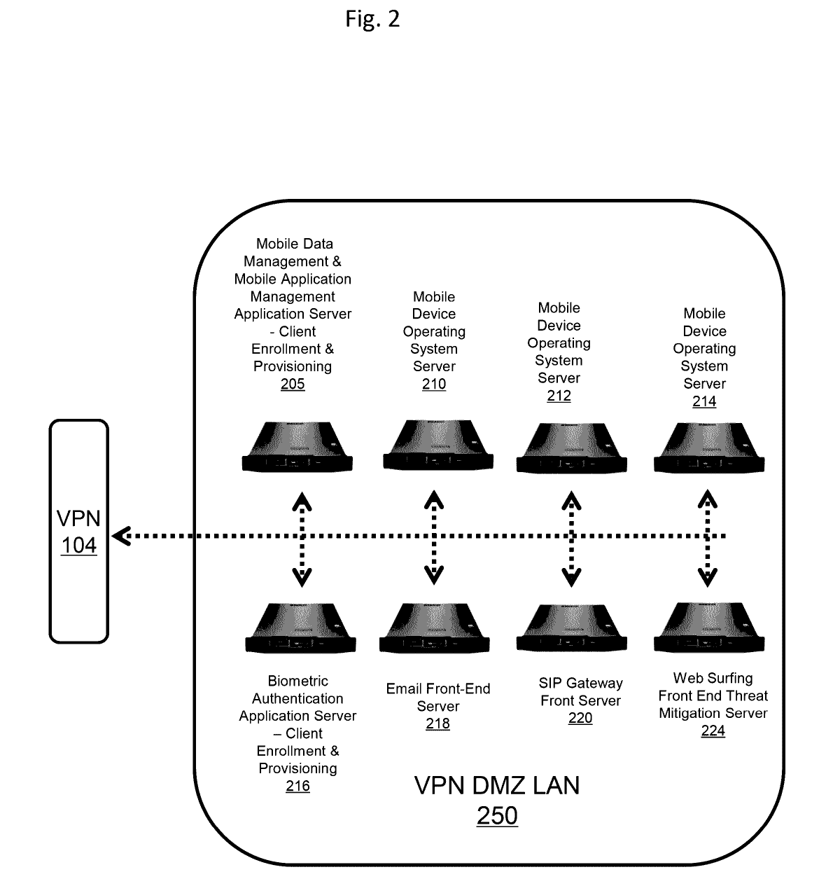

According to one or more embodiments, the first protection server 106 is an advanced malware and persistent threat mitigation application server. As shown in FIG. 2, the first protection server 106 comprises a server component and one or more software applications to be implemented, including, for example, a firewall barrier application, a first protection software application (e.g., a persistent threat application) and a second protection software application (e.g., an endpoint protection application). The firewall barrier application is comprises one or more modules configured to perform port blocking, port passing, demilitarized zone (DMZ) services such that a user only has access to the equipment in the DMZ, intelligent routing, bandwidth limiting, administrative reporting, and defense from malicious software (malware).

The first protection software application is configured to identify and prevent attacks delivered via the communication network (e.g., Internet) which may include drive-by downloads, attacks delivered via emails such as malicious attachments, detection and blocking of harmful content which can be obtained via the communication network (e.g., Internet). The first protection software application is further configured to protect the system 100 from system exploitation and data ex-filtration, in order to effectively stop attackers and enabling the aggregation and correlation of events by clearly identifying blended attacks and blocking covert callback channels.

According to one or more embodiments, the second protection software application may be a real-time sensor application to be downloaded to the communication devices 101, 102. The second protection software application 109 is configured to continuously monitor and record all activity on the endpoints of a communication session (i.e., from one communication device 101, 102 to another communication device 101, 102). Further, the second protection software application 109 is configured to track and record an arrival and execution of any file with executable code for making changes to memory in the communication devices 101, 102, process violations, attached external devices (e.g., USB device) and any file changes to the mobile device 101, 102.

According to one or more embodiments, the video conferencing server 110 comprises a video conferencing software application configured to perform secure video conferences for one or more communication devices 101, 102 when conferencing. When no more than two communication devices are conferencing a voice switch and conferencing server 116 may be used without the need to use the video conferencing server 110. Additional details regarding the voice switch and conferencing server 116 will be discussed below.

The video conferencing server 110 is configured to be a browser-based server and accommodates cross platform communication. For example, a communication device 101 (e.g., a smartphone) may perform video conference with other communication devices 102 (e.g., smartphones, or mobile devices (e.g., tablet devices). That is, according to one or more embodiments of the present invention, smartphones may video conference with other smartphones, tablet devices may video conference with other tablet devices, smartphones may video conference with tablet devices, and tablet devices may video conference with desktop or VoIP phones, etc. The present invention is not limited to any particular platform communication and may vary accordingly.

The client-specified server 114 comprises client-specific applications and services for each communication device 101, 102 (e.g., a mobile device). The client-specific applications and services are protected and segregated to their specific system platform within the system 100. The client-specific applications and services may include, for example, informational databases, interactive forms or surveys, billing systems, time and attendance applications, for example. The present invention is not limited to any particular number or type of client-specific applications and services and may vary accordingly. According to one or more embodiments, these client-specific applications and services reside within the client-specified server 114.

According to one or more embodiments, the voice switch and conferencing server 116 is a secure voice switch and voice switch and conferencing server which is an IP-based Private Branch Exchange (PBX) system that connects communication devices 101, 102 within the VPN LAN 150 to communication devices outside of the VPN LAN 150 including connection to mobile networks.

The voice switch and conferencing server 116 is configured to receive incoming calls and determining whether the call is internal or external of the system 100 and perform call switching, call routing, and call queuing.

According to another embodiment, the voice switch and conferencing server 116 may further include an encrypted web page configuration management functionality for providing functions such as voice mail, call conferencing, and call transfer.

According to one or more embodiments, the use of the voice switch and conferencing server 116 further eliminates the need for external voice communication channels when performing video conferencing via the video conferencing server 110. Further, the video conference sessions between the communication devices 101, 102 are protected by one of the encryption processes mentioned above, depending on a mode of operation of the communication devices 101, 102.

According to one or more embodiments, the notification server 118 is a Persistent session initiation protocol (SIP) adapter and PUSH notification server. The notification server 118 is configured to communicate with the voice switch and conferencing server 116 and to announce incoming calls received from therefrom. The notification server 118 is further configured to register with the voice switch and conferencing server 116 on behalf of the mobile application, e.g., a Mobile VoIP application, downloadable and installable, of the communication device 101, 102 such that when the mobile VoIP application is not running in the foreground on the communication device 101, 102 (i.e., when the mobile VoIP application is suspended or disabled to the background, or exited), the notification server 118 registers the communication device 101, 102 and detects any incoming calls. When an incoming call is detected, the mobile application is awoken (i.e., enabled) using PUSH technology or other client-specific messaging technology within an operating system of the mobile device 101, 102, at which time the incoming call is transferred to the mobile VoIP application. According to one or more embodiments, the mobile VoIP application turns the communication device 101, 102 into a SIP client, which then uses the VPN gateway 104 to send and receive SIP messaging.

According to one or more embodiments, the advantage of use of the notification server 118 is that the mobile application of the communication device 101, 102 does not continuously run at all times, and therefore saves battery power while still enabling the receiving of incoming calls. The data (e.g., audio and video) of the incoming call is transferred directly to the mobile application.

According to one or more other embodiments, the voice switch and conferencing server 116 is further configured to interface with both the notification server 118 and a SIP gateway front server 220 (as depicted in FIG. 2), to perform call initiation and call completion, and to ensure the stability of the voice communication.

Using the notification server 118, the mobile VoIP application and a software application capable of encoding or decoding a digital data stream or signal (e.g., a CODEC) installed or downloadable with the mobile VoIP application, are loaded or pushed to the communication device 101, 102. According to one or more embodiments, the CODEC is of a low delay format which supports high audio quality. Further the CODEC is configured for mobile internet use and for efficient adjustment between operating modes and changes in internet resources. The CODEC further comprises multiple software instruction routines to handle packet loss and reduce gaps (i.e., lost portions of conversations) in the communication path of the voice switch and conferencing server 116.

According to one or more embodiments of the present invention, the system 100 further includes a front-end email server 218 (as depicted in FIG. 2); and the back-end email/list server 120 as shown in FIG. 1. The front-end email server 218 is located in a VPN DMZ LAN 250 (as depicted in FIG. 2). The front-end email server 218 is used when communicating out of or in to the system 100. The front-end email server 218 comprises instructions to determine whether an email is to be transmitted inside of the system and does not store any email content or attachments. The front-end email server 218 further comprises a hardened simple mail transfer protocol (SMTP) application for sending and receiving external. According to other embodiments, the front-end email server 218 further comprises an open source email anti-spam application to filter out undesired email. When the inbound email has successfully completed the process at the front-end email server 218, the inbound email proceeds to the back-end email/list server for further processing. The back-end email server 120 comprises instructions to determine whether an email is to be transmitted inside or outside of the system 100 and processes for distribution and stores all email content and attachments. Referring back to FIG. 1, the back-end email/list server 120 is configured to receive the inbound email and store the data therein.

According to one or more embodiments, the authentication and access control server 122 is configured to verify the identity of a user attempting to access the system 100 and to perform access control to one or more resources based on the identity of the user as verified. The verification process of the user may be performed using biometrics via a dedicated server (e.g., a biometric authentication application server 216 (as depicted in FIG. 2)). If verification of the user is successful then a data message is sent to the authentication and control access server 122 from the biometric authentication application server 216 confirming verification thereof.

The authentication and access control server 122 is further configured to grant user access to a service, document or a specific server within the system 100. As mentioned, an access control list (ACL) may be provided and stored within the file server 105, to determine which operations of the system 100 can or cannot be accessed by a specific user.

According to one or more embodiments, the engineering management computing system 124 is configured for technical applications to be performed within the system 100. The engineering management computing system 124 is configured to allow one or more users at a time, to access the system 100 via the VPN gateway 104. The engineering management computing system 124 comprises multiple central processing unit (CPU) cores, high resolution graphics and dual displays, high speed high capacity memory and multitasking capabilities. The management computing system 116 may further include a keyboard, a mouse, graphics tablet for manipulating 3D objects and navigating scenes, and a high resolution scanner, for example.

According to one or more embodiments, similar to the engineering management computing system 124, the hybrid cloud client-provisioning computing system 126 is also configured for technical applications to be used by one or more users at a time when connected to the VPN LAN 150 by the VPN gateway 104. The hybrid cloud client-provisioning computing system 126 is further configured to be used by users for provisioning services individually or for others in their group, company or organization. Further, according to one or more embodiments, the hybrid cloud client-provisioning computing system 126 is a private computing environment in which a user organization manages selected resources (i.e., LAN segments e.g., servers, databases, etc.) internally and others are supported by a third-party provider of the system 100.

The security management computing system 128 is configured to update and maintain security features and services to all components (e.g., servers, appliances, and applications) within the VPN LAN 150. It is to be used by one or more users at a time when it is connected to the VPN LAN 150 by the VPN gateway 104.

FIG. 4 is a block diagram of a computing system 400 that can be implemented within one or more embodiments of the servers 105, 106, 110, 114, 116, 118 and 122 and the computing systems 124, 126, 128 shown in FIG. 1. The computing system 400 includes at least one microprocessor or central processing unit (CPU) 405. The CPU 405 is interconnected via a system bus 410 to a random access memory (RAM) 415, a read-only memory (ROM) 420, an input/output (I/O) adapter 425 for connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

The ROM 420 contains the basic operating system for the computer system 400. The operating system may alternatively reside in the RAM 415 or elsewhere as is known in the art. Examples or removable data and/or program storage device 430 include magnetic media such as floppy drives and tape drives and optical media such as CD ROM drives. Examples of mass data and/or program storage device 435 include hard disk drives and non-volatile memory such as flash memory. In addition to the keyboard 445 and the mouse 450, other user input devices such as trackballs, writing tablets, pressure pads, microphones, light pens, and position sensing screen displays may be connected to user the user interface 440. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 430, fed through data port 460 or typed in using the keyboard 445. In view of the above, the present method embodiment may therefore take the form of a computer or controller implemented processes and apparatuses for practicing those processes. This disclosure can also be embodied in the form of computer program code containing instructions embodied in tangible media, such as floppy diskettes, CD ROMs, hard drives, or any other computer-readable storage medium, wherein, when the computer program code is loaded into and executed by a computer or controller, the computer becomes an apparatus for practicing the invention. This disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above.

Now referring to FIG. 2, according to one or more embodiments, the system 100 further includes a subnet LAN, VPN Demilitarized Zone (DMZ) LAN 250 configured to protect application servers of the system 100 from intruders over the network. The VPN DMZ LAN 250 adds an additional layer of security to the VPN LAN 150 as depicted in FIG. 1, to protect against external attackers which only have direct access to external facing components of the VPN DMZ LAN 250 and not the vital information stored in the VPN LAN 150. According to one or more embodiments, the VPN DMZ LAN 250 is connected with the VPN LAN 150 via the VPN gateway 104. Thus, according to an embodiment of the present invention, a process or incoming data is required to be cleared by an application of the VPN DMZ LAN 250 prior to accessing the VPN LAN 150.

According to one or more embodiments, the VPN DMZ LAN 250 comprises multiple LAN segments including, for example, a mobile data management and mobile application management application server 205 (MDM server), multiple mobile device operating system software servers 210, 212, 214 corresponding to the operating systems of the communication devices 101, 102, a biometric authentication application server—client enrollment and provisioning 216, the front-end email server 218 corresponding to the back-end email/list server 120 (as depicted in FIG. 1), the SIP gateway front server 220 and a second protection server 224 which is a web surfing front end threat mitigation server. The present invention is not limited to any particular number or type of LAN segments being included in the VPN DMZ LAN 250, and may vary accordingly.

According to one or more embodiments, the MDM server 205 is configured to perform several operations associated with the communication devices 101, 102 including but not limited to activation, enrollment, security, device management, configuration and monitoring of the communication devices 101, 102. The MDM server 205 is capable of partitioning the communication device 101, 102 (e.g., the memory of the mobile device 101, 102), to separate personal and business (i.e., system 100 access side) of the communication device 101, 102. The user is required enter biometric information and login information (e.g., a pin code) to gain access to the system 100

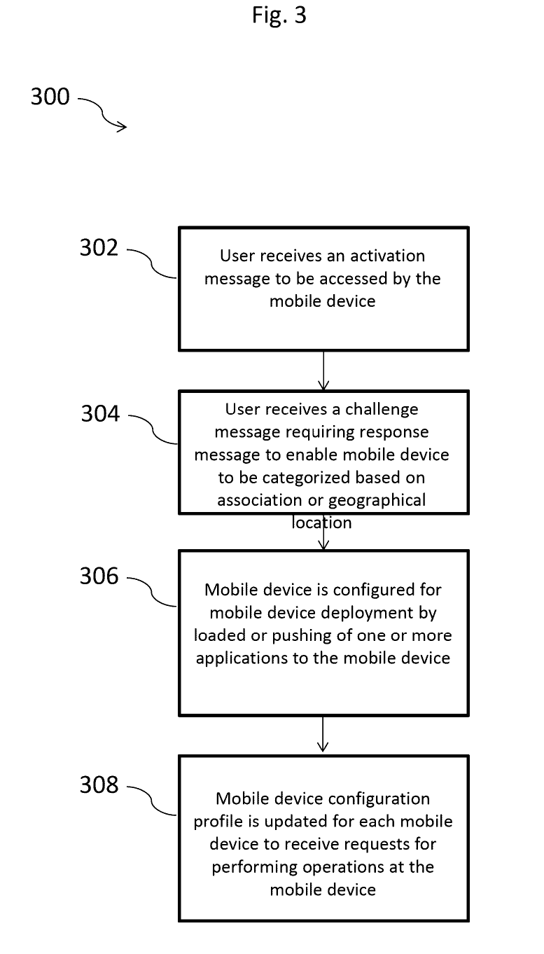

A method 300 of provisioning of the communication devices 101, 102 will now be discussed below with reference to FIG. 3.

As shown in FIG. 3, the method 300 begins with an activation operation of the communication device 101, 102 for communication within the system 100. According to one or more embodiments, the communication device 101, 102 may be a personal or business-owned communication device. According to this embodiment of the present invention, the provisioning method for protecting the communication devices 101, 102 is the same manner whether the device is a personal or business-owned communication device. According to other embodiments, the provisioning method may vary depending on the type of the communication device 101, 102. At operation 302, the user receives an activation message (e.g., email message) to be accessed via the communication device 101, 102. This operation provides the user with activation information including a provisioning uniform resource locator (URL) to the MDM server 205, login information and an activation code. According to one or more embodiments, the activation information is unique to the activation of each communication device 101, 102. From operation 302, the process continues to operation 304, where the user receives via the communication device 101, 102, an inquiry message requiring a response message from the user, to enable the communication device 101, 102 to be categorized based on company association or geographical location. That is, the communication device 101, 102 is placed into a subgroup based on a geographical location or organization associated with the communication device 101, 102. According to one or more embodiments, the MDM server 205 is configured to push a specific profile for the communication device 101, 102 based on the associated subgroup in which the communication device resides. For example, employees in one company who are in a one country can be grouped together to ensure compliance with privacy laws of the country.

Next, an enrollment operation begins at operation 306, where the communication device 101, 102 is configured for communication device deployment by loading or pushing of one or more applications to the communication device 101, 102. According to one or more embodiments, one or more communication devices 101, 102 may be configured for communication device deployment simultaneously. For example, a subgroup of communication devices 101, 102 in the same country, may be configured for communication device deployment at the same time. All of the communication devices 101, 102 require directory-based user authentication that in turn uses Active Directory based authentication using the biometric authentication application server—client enrollment and provisioning server 216. The users receive any end user terms of agreement and are required to comply with the terms of agreement in order to proceed with the enrollment operation. The communication device deployment configuration comprises loading of one or more software applications to the communication device 101, 102. For example, according to one or more embodiments, the one or more software applications may include but are not limited to an encryption application, a mobile VoIP application, an email application, a geographic location application, a file transfer application, a custom application to allow control over existing software applications of the communication device 101, 102, for example, for control over existing GPS technology of the communication device 101, 102, to enable monitoring of environmental and location information of the communication device 101, 102, SIP application, and a biometrics application. These software applications are obtained via the respective application servers of the VPN LAN 150 as depicted in FIG. 1.

According to one or more embodiments, the communication device 101, 102 is also provisioned to be passcode protected and storage cards of the communication devices 101, 102 may be encrypted to provide added security protection in the case of a user's device is required to be lock down to prevent access thereof including access to the device features, web browsers and applications loaded on the device in the event that the device is lost or stolen.

Further from operation 306, the process continues to 308 where device configuration profile is updated for each communication device 101, 102 to receive requests for performing operations at the device (e.g., locking the device, deleting and copying data files, etc., remotely using the MDM server 205. The configuration may be specific to a subgroup or individual device certificate, to accommodate multiple accounts (e.g., business or personal contacts, calendars, email, Wi-Fi and VPN networks).

According to one or more embodiments, once the communication device 101, 102 is provisioned, administrators of the system 100, may control the device 101, 102, to receive alerts (email messages or other notifications) triggered by specific events related to the communication device 101, 102 such as memory space capacity or addition/deletion of applications. Further, administrators are capable of receiving reports corresponding to use of each communication device 101, 102.

Referring back to FIG. 2, the communication device operating system (MDOS) software servers 210, 212, 214 are specific to the operating system and platform of the communication device 101, 102. The present invention is not limited to being used with any particular operating system and platform of the communication device 101, 102 and may vary accordingly. For example, the MDOS servers 210, 212 and 214 may be a Microsoft Windows® software server 210, Apple® software server 212, and an Android® software server 214 respectively are used to provide updates to the operating system of the respectively communication device 101, 102 when needed and to allow administrators to accept or decline updates before releasing and provide reporting and analysis of the operations when desired.

According to one or more embodiments, the biometric authentication application server 216 comprises different modes of operation including but not limited to stand-alone or connected.

When operating in a stand-alone mode, an application of the biometric application server 216 when loaded onto the communication device 101, 102, may operate as a stand-alone without needing to be connected with a wireless network or communication with the biometric authentication server 216. Thus, enrollment of the user's voice print for performing voice biometrics and eye vein pattern for eye biometrics can be accomplished via the application installed on the communication device 101, 102, during the provisioning method 300 of the communication device 101, 102, as depicted in FIG. 3. Further, the stand-alone mode may be performed when wireless communication is unavailable, for example, when on an airplane. Thus, the user may only be granted access to applications and information stored on the communication device 101, 102, itself to prevent risk of information loss or compromise to the system 100. Although voice and eye vein biometrics are discussed herein, the present invention is not limited hereto and any type of biometrics suitable for the purpose set forth herein may be implemented.

In the connected mode, the communication device 101, 102 comprises a biometric application downloaded thereto from the biometric authentication server 216, to transmit the user's biometric information to the biometric authentication server 216. The connected mode requires access to the biometric authentication server 216 and to the access network 103.

According to one or more embodiments, the SIP gateway front server 220 is configured to accept analog phone calls from sources external to the system 100 and converts them to SIP format to be used by the voice switch and conferencing server 116 as depicted in FIG. 1. The SIP gateway server 220 is an added security level to minimize the introduction of high bandwidth SIP data traffic directly into the VPN LAN 150 of the system 100 via the voice switch and conferencing server 116. Acceptance of analog calls into the VPN LAN 150 is introduced by means of analog data connections that act as digital air gaps into the system 100. In some embodiments, the SIP gateway front server 220 is only provisioned when required by the users or when local regulations for communication allow interconnection thereof

According to one or more embodiments, the second protection server 224 is configured to act as a buffer from a website a user of a communication device 101, 102 may web surf which is external to the system 100. Thus, the second protection server 224 mitigates any threats caused by external websites that may be set up to inject malware into the communication device 101, 102. Similarly to the SIP gateway front server 220, in some embodiments, the second protection server 224 is only provisioned when required by the users or when regulations for communication allow interconnection thereof.

FIG. 5 is a flowchart illustrating a method 500 of performing a call operation via a communication device 101, 102 within the system 100 according to one or more embodiments of the present invention. The communication device 101, 102 may be a fixed or mobile device communicating via a wired or wireless network. The access communication network 103 detects whether the incoming call is communicated via a wired or wireless network and performs switching between the wired and wireless network when necessary. That is, if the incoming call is from a fixed device and the receiving communication device 101, 102 is a mobile device, the network is switched from a fixed network to a wireless network when the call is transmitted to the VPN LAN 150, while if the incoming call is from a mobile device 101, 102 and the receiving device is a fixed device within the system 100, then the network is switched from a wireless network to a wired network. If the fixed device is a VoIP device the communication is performed over a wireless network.

As shown in FIG. 5, the method 500 begins at operation 502 where the voice switch and conferencing server 116 receives incoming calls into the system 100 and detects whether the call is internal of or external to the system 100. From operation 502, the process continues to operation 504 where the notification server 118 (as depicted in FIG. 1) communicates with the voice switch and conferencing server 116 and detects the incoming calls for the communication device 101, 102. From operation 504, the process continues to operation 506, where when an incoming call is detected, the mobile VoIP application of the communication device 101, 102 is awoken by means of using a push technology or other client-specific messaging technology within an operating system of the communication device 101, 102. From operation 506, the process continues to operation 508 where the incoming call is then transferred to the mobile VoIP application of the communication device 101, 102.

According to one or more embodiments, a protocol converter may be included in the notification server 118 and communicates with the push or messaging technology of the communication device 101, 102 and receives data therefrom and transforms the data by removing unnecessary call information, and stores the critical data while only sending necessary call data to the communication device 101, 102, via the operating system of the communication device 101, 102. According to one or more other environments, the protocol converter and/or the push technology may be located outside of the system 100 to prevent the identification of the system 100, thereby enhancing the security of the system 100.

FIG. 6 is a flowchart illustrating a method 600 of performing an outbound call operation via a communication device 101, 102 within the system 100 according to one or more embodiments of the present invention. The method 600 begins at operation 602 where the user initiates the mobile VoIP application on the communication device 101, 102. From operation 602, the process continues to operation 604 where the initiation of the mobile VoIP application activates the VPN gateway 104 and establishing a real-time data communication link through the voice switch and conferencing server 116. If the communication device 101, 102 is a fixed device the communication is performed over a fixed VPN.

From operation 604, the process continues to operation 606 where the user initiates a call and/or retrieves messages via voicemail, for example.

While the invention has been described in terms of its preferred embodiments, it should be understood that numerous modifications may be made thereto without departing from the spirit and scope of the present invention. It is intended that all such modifications fall within the scope of the appended claims.

What is claimed is:

1. A collaborative business communication information system, comprising:
one or more communication devices communicatively coupled to one or more networks; and
a virtual private network (VPN) accessible by the one or more communication devices via a communication access network, and configured to:
provision the one or more communication devices to communicate within the VPN,
monitor communication data between the one or more communication devices,
encrypt the communication data during transmission and when stored within the VPN,
detect and block intrusive activity of the communication data in real-time, and
perform a switching operation between the one or more networks in real-time, to provide an uninterrupted communication path between the one or more communication devices in communication with each other.

2. The system of claim 1, wherein the VPN further comprises:
a fixed VPN configured to facilitate communication between fixed devices using the system; and
a mobile VPN configured to perform communication between the one or more mobile devices including the switching operation between the one or more networks in real-time.

3. The system of claim 2, further comprising:
a video conferencing server configured to perform video conferencing using the one or more mobile devices; and
a voice switch and conferencing server configured to receive communication data and determine whether the communication data is internal to or external to the system, and to provide a voice communication channel during video conferencing.

4. The system of claim 3, wherein the video conferencing server is a browser-based server and is further configured to accommodate cross-platform communication.

5. The system of claim 3, wherein the voice switch and conferencing server is an internet-protocol (IP) based private branch exchange (PBX) system configured to communicatively connect the one or more mobile devices to each other.

6. The system of claim 5, further comprising subset VPN comprising:
a mobile data management server configured to provision the one or more communication devices for communication with the system and monitor the one or more mobile devices.

7. The system of claim 6, wherein provisioning of the one or more communication devices comprises installing a mobile application for performing communication using the one or more mobile devices.

8. The system of claim 7, wherein the mobile application is a mobile voice over internet protocol (VoIP) application.

9. The system of claim 8, further comprising:
a notification server communicatively coupled with the voice switch and conferencing server and configured to transmit communication data to the one or more communication devices via the mobile application.

10. The system of claim 9, wherein when the mobile application is disabled, the notification server is configured to enable the mobile application using a messaging technology of the one or more communication devices, to transfer the communication data to the one or more communication devices.

11. The system of claim 1, wherein the one or more communication devices are grouped into subgroups based on geographical location and/or association.

12. The system of claim 6, wherein the subset VPN further comprises one or more communication device operating system servers compatible with the one or more communication devices configure to provide updates to corresponding operating system of the one or more mobile devices.

13. The system of claim 12, further comprising an authentication and access control server configured to verify an identity of a user of a communication device of the one or more communication devices and to perform access control to one or more resources based on the identity of the user as verified.

14. The system of claim 13, further comprising a biometrics server configured to:
perform one or more biometric operations, in a connected mode, to verify the identity of a user for performing access control to the one or more resources; and
perform one or more biometric operations, in a stand-alone mode, at the one or more communication devices, to verify the identity of the user to gain access to the system.

15. A method implementing by a computer system to effect the provisioning of one or more communication devices to communicate within a collaborative business communication information system comprising a virtual private network (VPN), the method comprising:
sending an activation message to be accessed via the one or more communication devices wherein the activation message is different for each of the one or more communication devices;
sending an inquiry message requiring a response from a user of the one or more communication devices, to enable the one or more communication devices to be placed into a subgroup based on geographical location and/or association;
enrolling the one or more communication devices to communicate within system by configuring the one or more communication devices for deployment; and
updating a profile of the one or more communication devices to receive request for performing operations at the one or more communication devices upon completion of enrollment.

16. The method of claim 15, wherein the enrolling of the one or more communication devices comprises:
loading one or more applications to the one or more communication devices including at least one or more of an encryption application, a communication application, an email application, a geographic location application, a file transfer application, a control application for controlling existing applications of the one or more communication devices, session initiation protocol (SIP) application, and a biometric application.

17. The method of claim 16, further comprising controlling the one or more communication devices via the control application to restrict access to data within the one or more communication devices and to the secure communication network system during an intrusion event.

18. The method of claim 17, wherein performing a call operation via the one or more communication devices, comprises:
receiving an incoming call at a voice switch and conferencing server of the system;
pushing communication data of the incoming call to a communication application of the one or more communication devices via messaging technology of the one or more communication devices, wherein when the communication application is disabled, the communication application is enabled via a notification server in communication with the voice switch and conferencing server, and the communication data is pushed to the communication application via the notification server.

19. The method of claim 18, wherein the communication data is transformed to remove call information prior to being pushed to the communication application.

20. The method of claim 17, wherein performing an outbound call operation via the one or more communication devices comprises:
initiating the mobile application within the one or more communication devices;
activating a VPN gateway to gain access to the system; and
establishing a real-time data communication link through the voice switch and conferencing server of the system.

21. A computer readable medium storing computer executable instructions that, when executed, cause a computing device to perform a method of implementing the provisioning of one or more communication devices to communicate within a collaborative business communication information system comprising a virtual private network (VPN), the method comprising:
sending an activation message to be accessed via the one or more communication devices wherein the activation message is different for each of the one or more communication devices;
sending an inquiry message requiring a response from a user of the one or more communication devices, to enable the one or more communication devices to be placed into a subgroup based on geographical location and/or association;
enrolling the one or more communication devices to communicate within the system by configuring the one or more communication devices for deployment; and
updating a profile of the one or more communication devices to receive request for performing operations at the one or more communication devices upon completion of enrollment.

22. The computer readable medium of claim 21, wherein the enrolling of the one or more communication devices comprises:
loading one or more applications to the one or more communication devices including at least one or more of an encryption application, a mobile application, an email application, a geographic location application, a file transfer application, a control application for controlling existing applications of the one or more communication devices, session initiation protocol (SIP) application, and a biometric application.

23. The computer readable medium of claim 22, the method further comprising controlling the one or more communication devices via the control application to restrict access to data within the one or more communication devices and to the system during an intrusion event.

24. The computer readable medium of claim 21, wherein performing a call operation via the one or more communication devices, comprises:
receiving an incoming call at a voice switch and conferencing server of the system;
pushing communication data of the incoming call to a mobile application of the one or more communication devices via messaging technology of the one or more communication devices, wherein when the mobile application is disabled, the mobile application is enabled via a notification server in communication with the voice switch and conferencing server, and the communication data is pushed to the mobile application via the notification server.

25. The computer readable medium of claim 24, wherein the communication data is transformed to remove call information prior to being pushed to the mobile application.

26. The computer readable medium of claim 24, wherein performing an outbound call operation via the one or more communication devices comprises:
initiating the mobile application within the one or more communication devices;
activating a VPN gateway to gain access to the secure communication network system; and
establishing a real-time data communication link through the voice switch and conferencing server of the system.
